(19) United States
(12) Patent Application Publication
(10) Pub. No.: US 2022/0132269 A1
(43) Pub. Date: Apr. 28, 2022

(54) TERMINALS, INFORMATION PROCESSING METHOD, AND NON-TRANSITORY STORAGE MEDIUM

(71) Applicant: TOYOTA JIDOSHA KABUSHIKI KAISHA, Toyota-shi Aichi-ken (JP)

(72) Inventors: Takaharu Ueno, Nagoya-shi Aichi-ken (JP); Yu Nagata, Chofu-shi Tokyo (JP); Yurika Tanaka, Yokosuka-shi Kanagawa-ken (JP); Ryosuke Kobayashi, Nagakute-shi Aichi-ken (JP); Shintaro Matsutani, Kariya-shi Aichi-ken (JP); Syouta Komatsu, Toyota-shi Aichi-ken (JP)

(73) Assignee: TOYOTA JIDOSHA KABUSHIKI KAISHA, Toyota-shi Aichi-ken (JP)

(21) Appl. No.: 17/506,935

(22) Filed: Oct. 21, 2021

(30) Foreign Application Priority Data
Oct. 23, 2020 (JP) 2020-177982

(51) Int. Cl. H04W 4/02; H04W 4/90; H04W 4/80; H04W 8/00

(52) U.S. Cl. CPC H04W 4/023; H04W 4/90; H04W 8/005; H04W 4/80; H04W 4/025

(57) ABSTRACT

A terminal includes a control unit. The control unit is configured to transmit user information to one or more other terminals that are present within a predetermined range of the terminal. The user information is information for requesting for assisting a first user having a physical disability. The user information includes first information for identifying the first user and second information on the physical disability of the first user.

### CROSS-REFERENCE TO RELATED APPLICATION

This application claims priority to Japanese Patent Application No. 2020-177982 filed on Oct. 23, 2020, incorporated herein by reference in its entirety.

### BACKGROUND

### 1. Technical Field

The present disclosure relates to terminals, an information processing method, and a non-transitory storage medium that assist a user having a physical disability.

### 2. Description of Related Art

Japanese Unexamined Patent Application Publication No. 2019-139636 (JP 2019-139636 A) discloses a technology on a toll road user assisting device. In the technology disclosed in JP 2019-139636 A, a face image of a user who has arrived at a toll collection machine on a toll road is acquired. In addition, usage history information on using the toll road by the user identified by the face image is acquired. Further, based on the user's history information, it is determined whether a discount for a person having a physical disability has been applied to the user in the past. When the discount for a person having a physical disability has been applied to the user in the past, the user is guided to present a pocketbook for a person having a physical disability.

### SUMMARY

The present disclosure provides a technology that can appropriately assist a user having a physical disability.

A terminal according to a first aspect of the present disclosure includes a control unit. The control unit is configured to transmit user information for requesting for assisting a first user having a physical disability to one or more other terminals that are present within a predetermined range of the terminal. The user information includes first information for identifying the first user and second information on the disability of the first user.

In the first aspect, the control unit may search for the one or more other terminals that are present within the predetermined range of the terminal and that permits reception of the user information, and transmit the user information to the one or more other terminals found by the searching.

In the first aspect, the control unit may search for the one or more other terminals by sending a search signal for searching for the one or more other terminals within the predetermined range of the terminal and by receiving a permission signal transmitted from the one or more other terminals that have received the search signal.

In the first aspect, the control unit may determine whether a current situation of the first user is a predetermined situation requiring assistance, and, upon determining that the current situation of the first user is the predetermined situation requiring assistance, transmit the user information to the one or more other terminals.

In the first aspect, the control unit may determine whether the current situation of the first user is the predetermined situation based on position information on a current position of the terminal.

In the first aspect, the second information may include assistance information on the content of the assistance required by the first user.

In the first aspect, the first information may include position information on a current position of the terminal.

In the first aspect, communication with the one or more other terminals may be executed according to Bluetooth® Low Energy standard.

In the first aspect, the communication with the one or more other terminals may be executed via WiFi®.

An information processing method according to a second aspect of the present disclosure is executed by a computer that controls a terminal. The information processing method includes a step of generating user information for requesting for assisting a first user and a step of transmitting the user information to one or more other terminals that are present within a predetermined range of the terminal. The user information includes first information for identifying the first user having a physical disability and second information on the disability of the first user.

In the second aspect, the information processing method may further include a step of searching for the one or more other terminals that are present within the predetermined range of the terminal and that permit reception of the user information. The user information may be transmitted to the one or more other terminals found by the step of searching.

In the second aspect, the one or more other terminals may be searched for by sending a search signal for searching for the one or more other terminals within the predetermined range of the terminal and by receiving a permission signal transmitted from the one or more other terminals that have received the search signal.

In the second aspect, the information processing method may further include a step of determining whether a current situation of the first user is a predetermined situation requiring assistance. When the current situation of the first user is determined to be the predetermined situation, the user information may be transmitted to the one or more other terminals.

In the second aspect, whether the current situation of the first user is the predetermined situation may be determined based on position information on a current position of the terminal.

In the second aspect, the second information may include assistance information on the content of the assistance required by the first user.

In the second aspect, the first information may include position information on a current position of the terminal.

A third aspect of the present disclosure is a non-transitory storage medium storing a command to cause the computer to execute the information processing method.

A non-transitory storage medium according to a fourth aspect of the present disclosure is executable by a computer that controls a terminal and stores a command to cause the terminal to execute functions. The functions may include receiving user information for requesting for assisting a first user, and notifying the second user that a request for assisting the first user is received. The user information includes first information for identifying the first user and second information on the disability of the first user, and is transmitted from another terminal carried by the first user who is a user other than a second user and has a physical disability.

In the fourth aspect, the functions may further include, when the second user is notified that the request for assisting the first user is received, causing an output unit of the terminal to output output information that is generated based on the user information.

In the fourth aspect, the output unit of the terminal may include a display. The output information may be output in the output unit by causing a display to display the output information.

With the present disclosure, it is possible to appropriately assist a user having a physical disability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for schematically describing an assistance request system;

FIG. 2 is a diagram illustrating a schematic configuration of a first terminal;

FIG. 3 is a block diagram schematically illustrating an example of a functional configuration of each terminal;

FIG. 4 is a diagram illustrating an example of a table configuration of user information;

FIG. 5 is a diagram illustrating an example of output information output in a second terminal;

FIG. 6 is a flowchart illustrating a flow of information processing executed by a control unit of the first terminal;

FIG. 7 is a flowchart illustrating a flow of information processing executed by a control unit of the second terminal;

FIG. 8 is a sequence diagram for describing a flow of information communication between the first terminal and the second terminal;

FIG. 9 is a diagram illustrating another example of the table configuration of the user information; and

FIG. 10 is a diagram illustrating another example of the output information output in the second terminal.

### DETAILED DESCRIPTION OF EMBODIMENTS

A terminal of a first aspect of the present disclosure is a terminal carried by a first user having a physical disability (hereinafter, sometimes referred to as a “first terminal”). The disability of the first user may be any one of a congenital disability or an acquired disability. Moreover, the disability of the user is not limited to a disability officially recognized as a physical disability. The first terminal includes a control unit.

There is a case where the first user requires assistance from others in his/her vicinity due to his/her disability. Then, the control unit transmits user information to one or more other terminals present within a predetermined range of the first terminal. The other terminal is a terminal carried by a user other than the first user (hereinafter, sometimes referred to as a “second user”). The user information is information for requesting for assisting the user. Further, the user information includes the first information and the second information. The first information is information for identifying the first user. The second information is information on the disability of the first user.

When the other terminal receives the user information transmitted from the first terminal, the second user present in the vicinity of the first user and carrying the other terminal can recognize the presence of the first user and the fact that the first user requires assistance. At this time, the second user can identify the first user based on the first information included in the user information. In addition, the second user can grasp the content of the disability of the first user based on the second information included in the user information.

As described above, with the present disclosure, by transmitting the user information from the first terminal to the second terminal, the first user can request assistance from the second user and the second user can recognize the first user requiring assistance. Therefore, the first user can more easily receive assistance from the second user. Further, the second user can more easily assist the first user.

Hereinafter, detailed embodiments of the present disclosure will be described with reference to drawings. Unless otherwise specified, dimensions, materials, shapes, and relative arrangements of the components described in the present embodiment are not intended to limit the technical scope of the present disclosure.

### First Embodiment

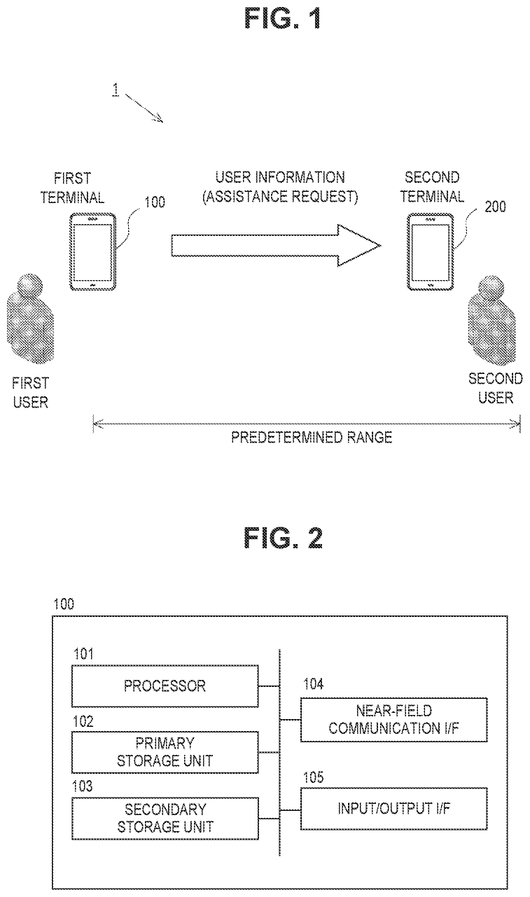

FIG. 1 is a diagram for schematically describing an assistance request system according to the present embodiment. An assistance request system 1 is a system that enables a user having a physical disability to request assistance from another person present in his/her vicinity. In FIG. 1, the first user is a user having a physical disability.

Further, the second user is a user other than the first user and present in the vicinity of the first user.

The assistance request system 1 includes a first terminal 100 and a second terminal 200. The first terminal 100 is a terminal carried by the first user. Moreover, the second terminal 200 is a terminal carried by the second user. When a plurality of second users carrying the second terminals is present in the vicinity of the first user, the assistance request system 1 includes a plurality of second terminals 200.

In the assistance request system 1, when the first user requires assistance from another person present in his/her vicinity, user information is transmitted to the second terminal 200 present within a predetermined range of the first terminal 100. The user information is information for requesting for assisting the first user. Further, the predetermined range may be a range in which the first terminal 100 can transmit the user information. When second terminals 200 are present within the predetermined range of the first terminal 100, the user information is transmitted to the second terminals 200. When the second terminal 200 receives the user information transmitted from the first terminal 100, the second user present within the predetermined range of the first user is requested to assist the first user. Details of the user information transmitted from the first terminal 100 will be described below.

FIG. 2 is a diagram illustrating a schematic configuration of the first terminal 100. The second terminal 200 has the same configuration as that of the first terminal 100. The first terminal 100 includes a computer having a processor 101, a primary storage unit 102, a secondary storage unit 103, a near-field communication interface (a near-field communication I/F) 104, and an input/output interface (input/output I/F) 105. Examples of the first terminal 100 and the second terminal 200 can include a smartphone, a tablet computer, or a wearable terminal.

Here, examples of the processor 101 include a central processing unit (CPU) or a digital signal processor (DSP). Examples of the primary storage unit 102 include a random access memory (RAM). Examples of the secondary storage unit 103 include a read-only memory (ROM) or a flash memory. Further, the secondary storage unit 103 may include a removable medium (a portable recording medium).

The near-field communication I/F 104 is an interface that enables the first terminal 100 to directly communicate with another terminal using a predetermined near-field wireless communication standard. As the predetermined near-field wireless communication standard, Bluetooth® Low Energy standard or WiFi® can be exemplified.

In the assistance request system 1, communication between the first terminal 100 and the second terminal 200 is executed according to such a predetermined near-field wireless communication standard. The input/output I/F 105 is an interface used for inputting and outputting information. The input/output I/F 105 includes, for example, a touch panel display.

In the first terminal 100 having the above configuration, an operating system (OS), various programs, various information tables, and the like, are stored in the secondary storage unit 103. Then, when the processor 101 loads the program stored in the secondary storage unit 103 into the primary storage unit 102 and executes the program, processing for requesting the second user to assist the first user, to be described below, is implemented. However, a part or all of the functions of the first terminal 100 may be implemented by a hardware circuit such as an ASIC or an FPGA. Each of the first terminal 100 and the second terminal 200 does not necessarily have to have a single physical configuration, and may be constituted with a plurality of computers that cooperate with each other.

### Functional Configuration

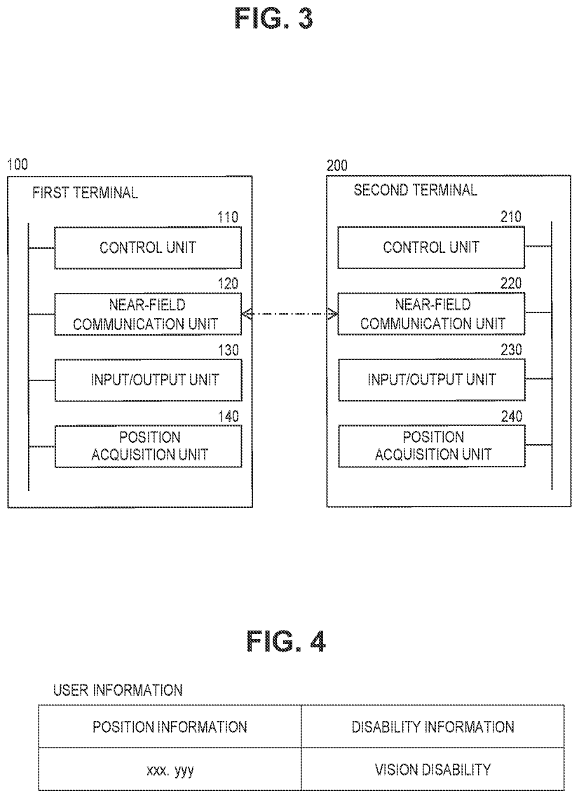

Next, a functional configuration of each of the first terminal 100 and the second terminal 200 that constitute the assistance request system 1 according to the present embodiment will be described with reference to FIG. 3. FIG. 3 is a block diagram schematically illustrating an example of the functional configuration of each of the terminals 100, 200.

The first terminal 100 has a control unit 110, a near-field communication unit 120, an input/output unit 130, and a position acquisition unit 140. The control unit 110 has a function of executing arithmetic processing for controlling the first terminal 100. The function of the control unit 110 can be implemented by the processor 101.

The near-field communication unit 120 has a function of communicating with the second terminal 200 present within a predetermined range of the first terminal 100 by the near-field wireless communication. The function of the near-field communication unit 120 can be implemented by the near-field communication I/F 104. Then, the control unit 110 executes processing for transmitting the user information using the near-field communication unit 120.

The input/output unit 130 has functions of receiving an input of information and outputting information. The function of the input/output unit 130 can be implemented by the input/output I/F 105. Then, the control unit 110 executes processing of receiving, using the input/output unit 130, the input of information by an operation of the first terminal 100 by the first user. Here, disability information, which is information on a physical disability of the first user, is input in advance to the first terminal 100 via the input/output unit 130. The input disability information is stored in the secondary storage unit 103.

The position acquisition unit 140 has a function of acquiring position information on a current position of the first terminal 100 (that is, position information on a current position of the first user carrying the first terminal 100). The function of the position acquisition unit 140 can be implemented by, for example, a GPS receiver provided in the first terminal 100.

Further, in the first terminal 100, the control unit 110 executes processing for generating the user information. FIG. 4 is a diagram illustrating an example of a table configuration of the user information generated by the control unit 110. As illustrated in FIG. 4, a user information table has a position information field and a disability information field. In the position information field, the position information of the first terminal 100 acquired by the position acquisition unit 140 is input. The position information input in the position information field is information indicating the position of the first user when the first user requires assistance from another person. Therefore, the position information input in the position information field functions as information for identifying the first user. Further, in the disability information field, disability information of the first user is input. FIG. 4 illustrates the user information when the first user has a vision disability. For that reason, in the disability information field, “vision disability” is input as the disability information.

Moreover, the second terminal 200 also has a control unit 210, a near-field communication unit 220, an input/output unit 230, and a position acquisition unit 240. In the second terminal 200 as well, the function of the control unit 210 can be implemented by a processor. The function of the near-field communication unit 220 can be implemented by the near-field communication I/F. The function of the input/output unit 230 can be implemented by the input/output I/F. The function of the position acquisition unit 240 can be implemented by a GPS receiver provided in the second terminal 200.

The control unit 210 has a function of executing arithmetic processing for controlling the second terminal 200. When the second terminal 200 is present within a predetermined range of the first terminal 100, the near-field communication unit 220 has a function of communicating with the first terminal 100 by the near-field wireless communication. Then, the control unit 210 executes processing for receiving, using the near-field communication unit 220, the user information transmitted from the first terminal 100.

Further, in the second terminal 200, the control unit 210 executes processing for generating output information based on the user information received from the first terminal 100. The output information is information for notifying the second user that the request for assisting the first user has been received. In addition, the control unit 210 executes processing for outputting the generated output information via the input/output unit 230. By outputting the output information in the second terminal 200, the second user is notified that the request for assisting the first user has been received. As a result, the second user can recognize the presence of the first user and the fact that the first user requires assistance.

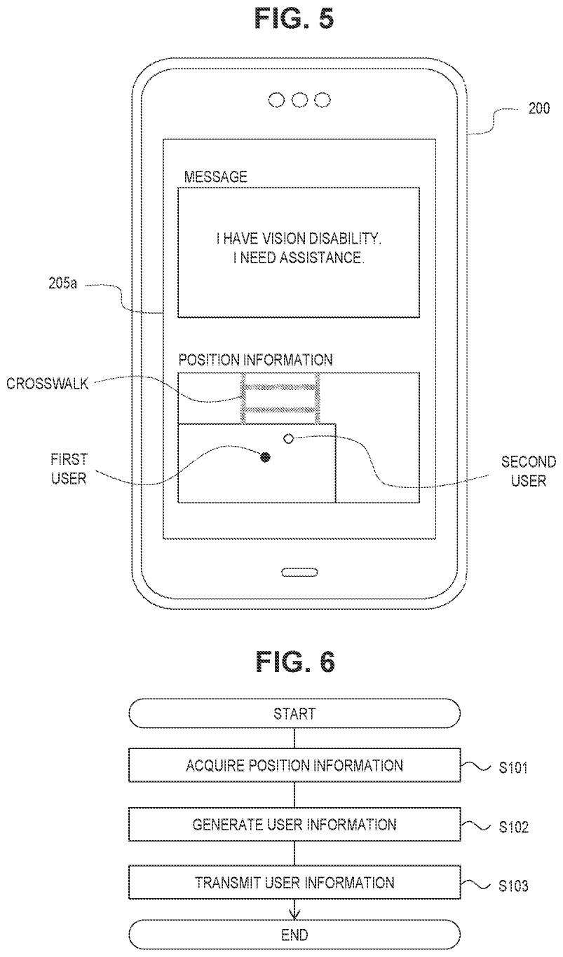

FIG. 5 is a diagram illustrating an example of the output information output in the second terminal 200. FIG. 5 illustrates the output information when the second terminal 200 receives the user information illustrated in FIG. 4. In FIG. 5, 205a is a touch panel display included in the input/output I/F constituting the input/output unit 230 of the second terminal 200. As illustrated in FIG. 5, a message and the position information are output as the output information to the touch panel display 205a.

The message output to the touch panel display 205a is generated based on the disability information included in the user information. In an example illustrated in FIG. 5, a message, “I have a vision disability. I need assistance” is displayed on the touch panel display 205a. Since such a message is displayed, the second user can grasp the content of the disability of the first user. The user information transmitted from the first terminal 100 may include a message that notifies the content of such a disability.

Moreover, the position information output to the touch panel display 205a is generated based on the position information on the current position of the first user included in the user information. In the example illustrated in FIG. 5, an image showing a positional relationship between the second user and the first user waiting on a sidewalk in front of a crosswalk to cross a road is displayed as the position information. Since such position information is displayed, the second user can identify the first user.

### Flow of Information Processing

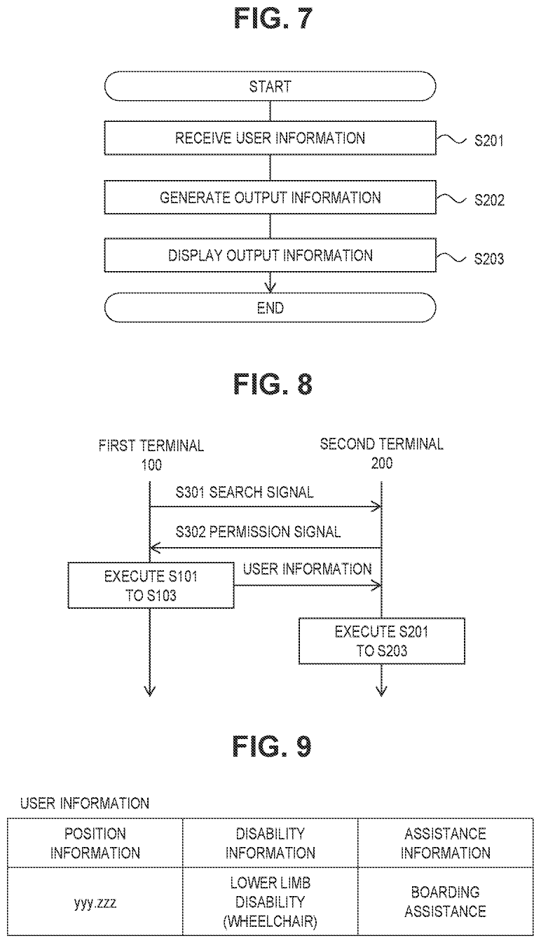

Next, in the assistance request system 1 according to the present embodiment, a flow of information processing executed by each of the first terminal 100 and the second terminal 200 will be described with reference to FIGS. 6 and 7. FIG. 6 is a flowchart illustrating the flow of information processing executed by the control unit 110 of the first terminal 100. FIG. 7 is a flowchart illustrating the flow of information processing executed by the control unit 210 of the second terminal 200.

The information processing illustrated in FIG. 6 is executed when the first user executes a prescribed operation on the first terminal 100 when the first user requires assistance from another person. In the flow illustrated in FIG. 6, first, in S101, the position information on the current position of the first terminal 100 is acquired. Next, in S102, the user information is generated based on the position information acquired in S101 and the disability information of the first user stored in advance in the first terminal 100. Next, in S103, the user information generated in S102 is transmitted to one or more second terminals 200 present within the predetermined range of the first terminal 100.

The information processing illustrated in FIG. 7 is executed when the second terminal 200 is present within the predetermined range of the first terminal 100, which is a source of the user information. In the flow illustrated in FIG. 7, first, in S201, the user information transmitted from the first terminal 100 is received. Next, in S202, output information is generated based on the user information received in S201. At this time, as illustrated in FIG. 5, when the positional relationship between the first user and the second user is output as the output information, position information on the current position of the second terminal 200 is acquired. Then, the output information is generated based on the user information received in S201 and the position information of the second terminal 200. Next, in S203, the output information generated in S202 is displayed on the touch panel display 205a of the second terminal 200.

As described above, with the assistance request system 1 according to the present embodiment, when the first user requires assistance from another person, the user information is transmitted from the first terminal 100 to the second terminal 200. As such, the first user can request assistance from the second user, and the second user can recognize the first user who requires assistance. Therefore, the first user can more easily receive assistance from the second user. Further, the second user can more easily assist the first user.

In the present embodiment, the position information included in the user information corresponds to “first information” according to the present disclosure. Further, the disability information included in the user information corresponds to “second information” according to the present disclosure.

In the present embodiment, the user information may include assistance information on the content of the assistance required by the first user, in addition to the position information and the disability information. In this case, the disability information and the assistance information included in the user information correspond to the “second information” according to the present disclosure.

In addition, when the user information includes the assistance information, the output information output in the second terminal 200 that has received the user information may include the content of the assistance required by the first user. For example, as illustrated in FIG. 5, when the first user is waiting on the sidewalk in front of the crosswalk to cross the road, the user information transmitted from the first terminal 100 may include assistance information, such as “assistance with crossing the road”. Then, in such a case, in the second terminal 200 that has received the user information, as the output information, the message, “I have a vision disability. I need assistance with crossing the road” may be displayed on the touch panel display 205a.

### Modified Example

Hereinbelow, a modified example of the present embodiment will be described. In the above embodiment, when the first user requires assistance from another person, the first user transmits the user information from the first terminal 100 by operating the first terminal 100. On the other hand, in this modified example, in the first terminal 100, the control unit 110 determines whether the current situation of the first user is a prescribed situation. Here, the predetermined situation is a situation where the first user requires assistance from another person. Then, when the control unit 110 has determined that the current situation of the user is the predetermined situation, the user information is transmitted from the first terminal 100 to the second terminal 200.

In this modified example, for example, the control unit 110 may determine whether the current situation of the first user is the predetermined situation based on the position information of the first terminal 100. Specifically, one or more places in which the control unit 110 can determine that the first user requires assistance from another person are registered in advance in the first terminal 100. Then, when the current position of the first terminal 100 is in a place registered in advance, the control unit 110 may determine that the current situation of the first user is the predetermined situation. In addition, there is a case where a sensor that can detect biological information of the first user is provided in the first terminal 100. In such a case, the control unit 110 may determine whether the current situation of the first user is the predetermined situation based on the biological information of the first user detected by the sensor. In addition, whether the current situation of the first user is the predetermined situation may be determined by any well-known method.

With such a modified example, when the first user requires assistance from another person, it is possible to request assistance from the second user even when the first user himself/herself does not operate the first terminal 100.

### Second Embodiment

Similar to the first embodiment, in the present embodiment as well, the assistance request system 1 includes the first terminal 100 carried by the first user and the second terminal 200 carried by the second user. Moreover, in the present embodiment, the first terminal 100 transmits the user information to the second terminal 200 present within the predetermined range of the first terminal 100. Hereinafter, the difference between the assistance request system 1 according to the present embodiment and that of the first embodiment will be mainly described.

FIG. 8 is a sequence diagram for describing a flow of information communication between the first terminal 100 and the second terminal 200 in the present embodiment. In the present embodiment, when the first user requires assistance from another person present in his/her vicinity, a search signal is sent from the first terminal 100 (S301). The search signal is a signal for searching for the second terminal 200. At this time, in the first terminal 100, the control unit 110 sends, using the near-field communication unit 120, the search signal within a predetermined range of the first terminal 100.

When the first user requires assistance from another person, the first user may transmit the search signal from the first terminal 100 by operating the first terminal 100. In addition, as in the modified example of the first embodiment, in the first terminal 100, the control unit 110 may determine whether the current situation of the first user is the predetermined situation, and then, when the control unit 110 has determined that the current situation of the first user is the predetermined situation, the search signal may be transmitted from the first terminal 100.

The search signal transmitted from the first terminal 100 is received by the second terminal 200 present within the predetermined range of the first terminal 100. Then, when the second user carrying the second terminal 200 intends to assist the first user, a permission signal is transmitted from the second terminal 200 to the first terminal 100 (S302). The permission signal is a signal indicating that the second terminal 200 permits reception of the user information from the first terminal 100. At this time, the control unit 210 in the second terminal 200 transmits, using the near-field communication unit 220, the permission signal.

In the second terminal 200, whether to transmit the permission signal when the search signal is received from the first terminal 100 is set in advance by the second user. In other words, when the second user intends to assist the first user when he/she encounters the first user who requires assistance from another person, the second terminal 200 is set to transmit the permission signal when receiving the search signal.

Then, when the first terminal 100 receives the permission signal from the second terminal 200, processing for transmitting the user information to the second terminal 200 is executed. Specifically, in the first terminal 100, the processes S101 to S103 in the flow of the information processing illustrated in FIG. 6 are executed. However, in this case, the control unit 110 of the first terminal 100 transmits the user information to the second terminal 200, which is the source of the permission signal. Moreover, at this time, when a plurality of second terminals 200 has sent permission signals, the control unit 110 transmits the user information to the second terminals 200.

Then, when the second terminal 200 receives the user information from the first terminal 100, processing for outputting the output information is executed. Specifically, in the second terminal 200, the processes S201 to S203 in the flow of the information processing illustrated in FIG. 7 are executed.

With the information processing, the first terminal 100 transmits the user information to the second terminal 200, which is present within the predetermined range of the first terminal 100 and permits the reception of the user information. As such, the first user can request assistance only from the second user who intends to assist the first user.

The assistance request system 1 according to the present embodiment can be used when, for example, a first user who is sitting in a wheelchair due to a lower limb disability requests for assistance with boarding a train or assistance with exiting from a train from a station employee or a conductor. In such a case, when the first terminal 100 sends the search signal, the second terminal 200 carried by the station employee or the conductor, who is the second user, transmits the permission signal.

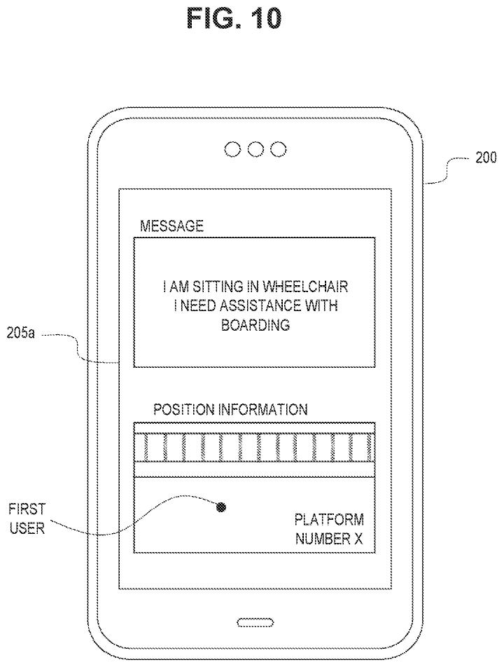

Hereinafter, the user information transmitted from the first terminal 100 and the output information output from the second terminal 200 when the assistance request system 1 is used in the above case will be described with reference to FIGS. 9 and 10. FIG. 9 is a diagram illustrating an example of a table configuration of the user information transmitted from the first terminal 100 when the first user sitting in the wheelchair requests for assistance with boarding the train from the station employee. FIG. 10 is a diagram illustrating an example of the output information output in the second terminal 200 when the second terminal 200 carried by the station employee who is the second user receives the user information illustrated in FIG. 9.

As illustrated in FIG. 9, the user information has an assistance information field in addition to the position information field and the disability information field. In the assistance information field, the assistance information on the content of assistance required by the first user is input. Then, in the user information illustrated in FIG. 9, in the disability information field, “lower limb disability (wheelchair)” is input as the disability information. Moreover, in the assistance information field, “boarding assistance” is input as the assistance information.

In addition, as illustrated in FIG. 10, a message and the position information are output as the output information on the touch panel display 205a of the second terminal 200. The message output on the touch panel display 205a is generated based on the disability information and the assistance information included in the user information. In the example illustrated in FIG. 10, the message, “I am sitting in a wheelchair. I need assistance with boarding.” is displayed on the touch panel display 205a. Since such a message is displayed, the second user (the station employee) can grasp the content of the disability of the first user and the content of assistance required by the first user. The user information transmitted from the first terminal 100 may include a message that notifies the content of such a disability and the content of such assistance.

Further, in the example illustrated in FIG. 10, an image showing the current position of the first user waiting for the train at a platform of a station is displayed as the position information. Since such position information is displayed, the second user (the station employee) can identify the first user. Similar to the example of the output information illustrated in FIG. 5, the position information in the output information illustrated in FIG. 10 is also generated based on the position information on the current position of the first user included in the user information.

In addition, for example, when the first user sitting in the wheelchair requests for assistance with exiting from the train from the conductor, the user information is transmitted from the first terminal 100 to the second terminal 200 carried by the train conductor who is the second user. At this time, in the assistance information field of the user information transmitted from the first terminal 100, “exiting assistance” may be input as the assistance information. Then, when the second terminal 200 receives the user information, the message, “I am sitting in a wheelchair. I need assistance with exiting.” may be displayed on the touch panel display 205a as the output information.

In the above-described first embodiment and second embodiment, the position information on the current position of the first user is used as the “first information for identifying the first user” in the present disclosure. However, the “first information” in the present disclosure is not limited to the position information of the first user. For example, image information on an image showing an appearance of the first user may be used as the “first information” in the present disclosure. In addition, the “first information” of the present disclosure may be any information as long as the second user who carries the second terminal 200 that has received the user information can identify the first user with the information.

### Other Embodiments

The above embodiments are merely examples, and the present disclosure can be appropriately modified and implemented within a range not departing from the gist of the present disclosure. Moreover, the processes and the elements described in the present specification can be freely combined and implemented as long as no technical inconsistency occurs.

Further, the processing described as being executed by a single device may be executed in a shared manner by a plurality of devices. Alternatively, the processing described as being executed by different devices may also be executed by a single device. In the computer system, the hardware configuration (the server configuration) that implements each function can be flexibly changed.

The present disclosure can also be implemented by supplying a computer with a computer program the implements the functions described in the embodiments, and reading and executing the program by one or more processors included in the computer. Such a computer program may be provided to a computer via a non-transitory computer-readable storage medium that can be connected to a system bus of the computer, or may be provided to the computer via a network. Examples of the non-transitory computer-readable storage medium include any type of disk such as a magnetic disk (floppy® disk, hard disk drive (HDD), and the like) and an optical disk (a CD-ROM, a DVD disk, a Blu-ray disk, and the like)), and any type of medium appropriate for storing an electronic command such as a ROM, a RAM, an EPROM, an EEPROM, a magnetic card, a flash memory, and an optical card.

What is claimed is:

1. A terminal comprising:
a control unit, wherein the control unit is configured to transmit user information for requesting for assisting a first user having a physical disability to one or more other terminals that are present within a predetermined range of the terminal, the user information including first information for identifying the first user and second information on the physical disability of the first user.

2. The terminal according to claim 1, wherein the control unit is configured to:
search for the one or more other terminals that are present within the predetermined range of the terminal and that permits reception of the user information; and
transmit the user information to the one or more other terminals found by searching.

3. The terminal according to claim 2, wherein the control unit is configured to search for the one or more other terminals by sending a search signal for searching for the one or more other terminals within the predetermined range of the terminal and by receiving a permission signal transmitted from the one or more other terminals that have received the search signal.

4. The terminal according to claim 1, wherein the control unit is configured to:
determine whether a current situation of the first user is a predetermined situation requiring assistance; and
upon determining that the current situation of the first user is the predetermined situation requiring assistance, transmit the user information to the one or more other terminals.

5. The terminal according to claim 4, wherein the control unit is configured to determine whether the current situation of the first user is the predetermined situation based on position information on a current position of the terminal.

6. The terminal according to claim 1, wherein the second information includes assistance information on content of assistance required by the first user.

7. The terminal according to claim 1, wherein the first information includes position information on a current position of the terminal.

8. The terminal according to claim 1, wherein communication with the one or more other terminals is executed according to Bluetooth® Low Energy standard.

9. The terminal according to claim 1, wherein communication with the one or more other terminals is executed via WiFi®.

10. An information processing method executed by a computer that controls a terminal, the information processing method comprising:
generating user information for requesting for assisting a first user, the user information including first information for identifying the first user having a physical disability and second information on the physical disability of the first user; and
transmitting the user information to one or more other terminals that are present within a predetermined range of the terminal.

11. The information processing method according to claim 10, further comprising:
searching for the one or more other terminals that are present within the predetermined range of the terminal and that permits reception of the user information,
wherein the user information is transmitted to the one or more other terminals found by the searching.

12. The information processing method according to claim 11, wherein the one or more other terminals is searched for by sending a search signal for searching for the one or more other terminals within the predetermined range of the terminal and by receiving a permission signal transmitted from the one or more other terminals that have received the search signal.

13. The information processing method according claim 10, further comprising:
determining whether a current situation of the first user is a predetermined situation requiring assistance,
wherein when the current situation of the first user is determined to be the predetermined situation, the user information is transmitted to the one or more other terminals.

14. The information processing method according to claim 13, wherein whether the current situation of the first user is the predetermined situation is determined based on position information on a current position of the terminal.

15. The information processing method according to claim 10, wherein the second information includes assistance information on content of assistance required by the first user.

16. The information processing method according to claim 10, wherein the first information includes position information on a current position of the terminal.

17. A non-transitory storage medium storing a command to cause the computer to execute the information processing method according to claim 10.

18. A non-transitory storage medium executable by a computer that controls a terminal and storing a command to cause the terminal to execute following functions:
receiving user information for requesting for assisting a first user, the user information being transmitted from another terminal carried by the first user who is a user other than a second user and has a physical disability; and
notifying the second user that a request for assisting the first user is received,
wherein the user information includes first information for identifying the first user and second information on the physical disability of the first user.

19. The non-transitory storage medium according to claim 18, wherein the functions further include, when the second user is notified that the request for assisting the first user is received, causing an output unit of the terminal to output output information that is generated based on the user information.

20. The non-transitory storage medium according to claim 19, wherein:
the output unit of the terminal includes a display; and
the output information is output in the output unit by causing the display to display the output information.
